(19) United States
(12) Patent Application Publication
(10) Pub. No.: US 2014/0076959 A1
(43) Pub. Date: Mar. 20, 2014

(54) SOLDER PASTE PRINT SQUEEGEE AND METHOD OF PRINTING USING THE SAME

(71) Applicant: SAMSUNG ELECTRO-MECHANICS CO., LTD., Suwon (KR)

(72) Inventors: Yeo Park, Daejeon (KR); Jae Soo LEE, Chungjoo (KR)

(73) Assignee: SAMSUNG ELECTRO-MECHANICS CO., LTD., Suwon (KR)

(21) Appl. No.: 14/030,460

(22) Filed: Sep. 18, 2013

(30) Foreign Application Priority Data
Sep. 20, 2012 (KR) 10-2012-0104451

(51) Int. Cl. B23K 1/20; B23K 3/08

(52) U.S. Cl. CPC B23K 1/20; B23K 3/08
USPC 228/248.1; 228/33

(57) ABSTRACT

Disclosed herein are a solder paste print squeegee and a method of using the same. The solder paste print squeegee includes: a rotation module driven rotatably; a pair of rods coupled with the rotation module in parallel; a squeegee holder coupled with the lower ends of the pair of rods and having a trapezoid shape; and a pair of squeegee blades supported by the squeegee holder.

### CROSS REFERENCE(S) TO RELATED APPLICATIONS

This application claims the benefit under 35 U.S.C. Section 119 of Korean Patent Application Serial No. 10-2012-0104451, entitled “Solder Paste Print Squeegee Apparatus and Method of Using the same” filed on Sep. 20, 2012, which is hereby incorporated by reference in its entirety into this application.

### BACKGROUND OF THE INVENTION

1. Technical Field

The present invention relates to a solder paste print squeegee and a method of using the same, and more particularly, to a solder paste print squeegee in which two squeegee blades having different lengths are in tight contact with each other, and a method of using the same.

2. Description of the Related Art

In general, printed circuit boards (PCBs) serve to easily connect several electronic components to one another according to a type frame. PCBs are widely used in all kinds of electronic products from home appliances such as digital TVs to high-end communication devices, and divided into general PCBs, module PCBs, and package PCBs depending on the purposes.

PCBs are formed by attaching a thin plate such as copper on one side of a phenol resin or epoxy resin, etching according to wire patterns of circuits to configure necessary circuits (removing by corroding them leaving circuits on lines), and making holes for mounting components. PCBs are divided into single-sided boards, doubled-sided boards, and multilayered boards, and a PCB having more layers can mount more components so that it is used in high precision products. Recently, thanks to the evolution of electronic industry, ultra-thin plate PCBs having a thickness from 0.04 mm to 0.2 mm are being widely used.

On a circuit board, melted solder paste is applied in a certain pattern so that various kinds of small electronic components such as semiconductor chips or resistor chips can be mounted on its surface. Examples of applying methods of solder paste largely include screen printing that directly prints solder paste pattern using a plate, roller coating that thinly applies solder paste having relatively low viscosity onto a rubber roller to coat a circuit board with it, curtain coating that uses solder paste having even lower viscosity than the roller coating so as to push out the solder paste through a slit to form a curtain-like film, and to pass a circuit board through the film, and spray coating that sprays solder paste to form a coating film on a circuit board.

Among those applying methods of solder paste, the screen printing method is commonly used, which is carried out by a solder paste applying apparatus. In the screen printing, solder paste is provided over a metal mask having openings of certain patterns formed therein, and the solder paste is pressed by a squeegee blade so as to be applied onto the component-mounting surface of a circuit board.

Occasionally, the squeegee blade that slides in order to print the solder paste may partially remove the solder paste that the squeegee blade has filled, such that it is difficult to completely apply solder paste on a circuit board by sliding the squeegee one time.

That is, the conventional solder paste printing method requires secondary printing process to complete printing of a circuit board.

In addition, when filling a large area, one squeegee blade harms volume uniformity of the bumps, such that an additional process of printing may be separately required depending on area.

### RELATED ART DOCUMENTS

### Patent Documents

(Patent Document 1) Korean Patent Laid-Open Publication No. 2006-0062628

(Patent Document 2) Japanese Patent Laid-Open Publication No. 1995-164614

### SUMMARY OF THE INVENTION

An object of the present invention is to provide a solder paste print squeegee having two coupled squeegee blades, and a method of printing using the same.

According to an exemplary embodiment of the present invention, there is provided a solder paste print squeegee including: a rotation module driven rotatably; a pair of rods coupled with the rotation module in parallel; a squeegee holder coupled with the lower ends of the pair of rods and having a trapezoid shape; and a pair of squeegee blades supported by the squeegee holder.

The pair of squeegee blades may include a first squeegee blade shorter than a second squeegee blade.

The material of one squeegee blade of the pair of squeegee blades may be the same with or different from that of the other squeegee blade.

The thickness of the squeegee blades may be chosen based on the shape of a metal mask and the like.

According to another exemplary embodiment of the present invention, there is provided a method of printing solder paste on a circuit board, including: locating a circuit board under a screen print mask; placing on the mask a solder paste print squeegee having a first squeegee blade and a second squeegee blade integrally coupled with each other; first printing solder paste on the circuit board by sliding the solder paste print squeegee from one side to the other side of the mask; detaching the printed circuit board and locating a new circuit board; supplementing solder paste; and second printing bumps on the circuit board by sliding from the other side to the one side of the solder paste print squeegee.

### BRIEF DESCRIPTION OF THE DRAWINGS

FIG. 1 is a front view illustrating a solder paste print squeegee according to an exemplary embodiment of the present invention;

FIGS. 2A to 2D are diagrams schematically showing processes for illustrating a method of printing solder paste according to the exemplary embodiment shown in FIG. 1;

FIG. 3 is a front view illustrating a solder paste print squeegee according to an exemplary embodiment of the present invention;

FIG. 4 is a front view illustrating a solder paste print squeegee according to an exemplary embodiment of the present invention;

FIG. 5A is a perspective view of dissembled squeegee projection and squeegee blade; and

FIGS. 5B and 5C are cross-sectional view of assembled squeegee projection and squeegee blade according to an exemplary embodiment of the present invention.

### DESCRIPTION OF THE PREFERRED EMBODIMENTS

The above and other objects, features and advantages of the present invention will be more clearly understood from the following detailed description taken in conjunction with the accompanying drawings. In the specification, in numbering elements in each drawing, it is to be noted that same elements appearing on different drawings will have the same reference number whenever possible. Further, in describing the present invention, descriptions on well-known features may be omitted in order not to obscure the gist of the present invention.

In the specification, the terms “first,” “second,” and so on are used to distinguish between similar elements and not necessarily for describing a sequential or chronological order.

Hereinafter, exemplary embodiments of the present invention will be described in detail with reference to the accompanying drawings.

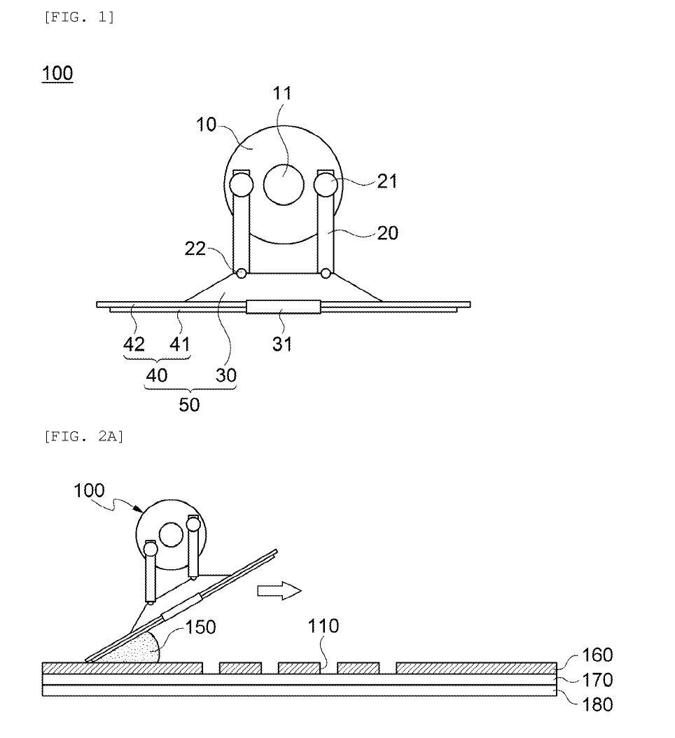

FIG. 1 is a front view illustrating a solder paste print squeegee according to an exemplary embodiment of the present invention.

Referring to FIG. 1, a squeegee 100 includes a rotation module 10 rotatably driven; a pair of rods 20 coupled with the rotation module 10 in parallel; a squeegee holder 30 coupled with the lower end of the rods 20 and having a trapezoid shape; and a pair of squeegee blades 40 supported by the squeegee holder 30.

The squeegee blade holder 30 and the pair of squeegee blades 40 may form a gradient forming unit 50.

The rotation module 10 has a circular shape having a rotation shaft 11 in its center, and may rotate in the vertical direction with the rotation of the center shaft. The rotation module 10 may rotate in one direction or the other direction at 90° or less with respect to when the squeegee blades 40 are level.

Additionally, to the rotation shaft 11 of the rotation module 10, moving means to facilitate the sliding of the squeegee 100 may be added, and elevating/descending driving means (not shown) to facilitate vertical movement may be further coupled. With this configuration, a general printing process of solder paste may be controlled such as moving and sliding of a squeegee, processing solder paste into a ring shape, or sliding in the opposite direction.

The pair of rods 20 may be coupled with the rotation module 10. Each of the rods 20 is of the same length, and is coupled with the rotation module 10 by a first fastening unit 21.

Here, the positions where the rotation module 10 and the pair of rods 20 are coupled by the first fastening units 21 may be symmetric with respect to the rotation shaft 11 of the rotation module 10 and spaced apart at a predetermined distance. The coupled portions are spaced apart at a predetermined distance with respect to the rotation shaft 11, preferably at an equal distance in order to improve accuracy in controlling the gradient of the squeegee blades 40.

Due to the way how the first fastening units 21 are coupled, the pair of rods 20 face downwardly even with the rotation of the rotation module 10, and each of the rods coupled with the rotation module 10 can be level. Accordingly, the rotation of the rotation module 10 may make a difference in height between the rotation module 10 and the first fastening units 21 to each of which the respective rods 20 are fastened.

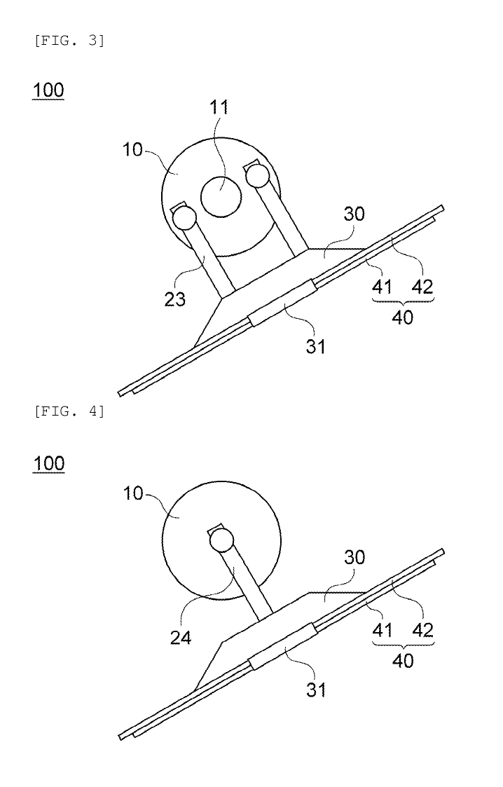

Referring to FIG. 3 or 4, the pair of rods may consist of at least one rod and be fixed to the rotation module 10. Unlike the rods 20 which are connected by the first fastening units 21 so that they only have a difference in height but are maintained parallel downwardly, the stick-like rods 23 and 24 are originally fixed to the rotation module 10, such that they rotate with the rotation module 10. Accordingly, the rods 23 and 24 are not level with respect to the ground but may create a certain angle with the ground by the rotation angle of the rotation module 10.

At the ends of the pair of rods 20, a squeegee holder 30 having a trapezoid shape may be coupled to hold squeegee blades. The squeegee holder 30 may be coupled with the rods 20 by the second fastening units 22. A difference in heights between the rods 20 by the rotation of the rotation module 10 may be equal to that between the second fastening units 22 (a difference in heights between the first fastening units 21).

Since the gradient forming unit 50 configuring the squeegee holder 30 and the squeegee blade 40 should be tightly contact with a certain pressure when it pushes forward solder paste over the mask during the printing of the solder paste, the rotation module 10 and the rods 20 may be fixed to the first fastening units 21 before the printing begins, and may be released for changing direction of the gradient forming unit 50 after the printing is completed.

Here, the squeegee holder 30 may include a squeegee projection 31 for fixing the squeegee blades 40 at the center of its bottom. The squeegee blades 40 may be coupled at the bottoms of the squeegee holder 30 and the squeegee projection 31.

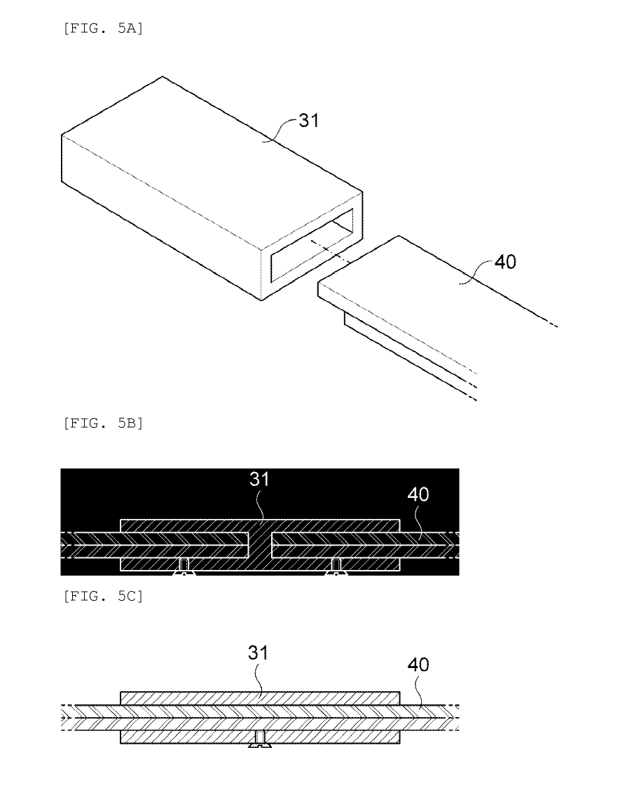

Here, in order to easily replace the first or second blade 41 or 42, the squeegee projection 31 may separate the squeegee holder 30 into the left and right parts, and have a hole from the center to the outside of the squeegee holder 30 (see FIG. 5B.)

The squeegee projection 31 may have a hole so that the rod-like first squeegee blade 41 and the second squeegee blade 42 integrally coupled are fixed by being surrounded by squeegee projection 31 (see FIG. 5C).

In the squeegee blades 40, since the first squeegee blade 41 is one used in the preceding printing than the second squeegee blade 42 during printing the solder paste, the length of the first squeegee blade 41 may be shorter than that of the second squeegee blade 42.

Here, since the first and second squeegee blades 41 and 42 should be in tight contact without generating a gap between the mask and the squeegee blades 40 in order to finish the printing of solder paste on the circuit board at one time during the sliding, the lengths of the first and second squeegee blades 41 and 42 may be suitably adjusted using a groove in the squeegee projection 31 of the gradient forming unit 50.

In addition, the squeegee blades 40 may have the first and second squeegee blades 41 and 42 having different thicknesses. In order to handle different masks, i.e., by selecting squeegee blades having different thickness depending on the sizes of holes on the mask, it is possible to obtain a spaced distance between the first and second squeegee blades 41 and 42, and accordingly, solder paste may be printed on a circuit board by replacing the squeegee blades 40 having different thicknesses without replacing the squeegee 100.

The squeegee blades 40 may be of the same or different material depending on the printing purpose. Preferably, the first squeegee blade 41 is made of a blade including urethane so as to maximize the ability of filling, and the second squeegee blade 42 is made of a metal-based blade so as to supplement bump volume partially swept by the first squeegee blade 41, even though the metal-based blade is poorer in filling. Accordingly, by configuring the first and second squeegee blades 41 and 42 with a different material, it is possible to print various shapes of bumps by only replacing squeegee blades 40.

The squeegee 100 may include a control unit to control the gradient of the squeegee blades 40, the proceeding directivity, contact of the squeegee blades 40 with the mask, and the sliding process.

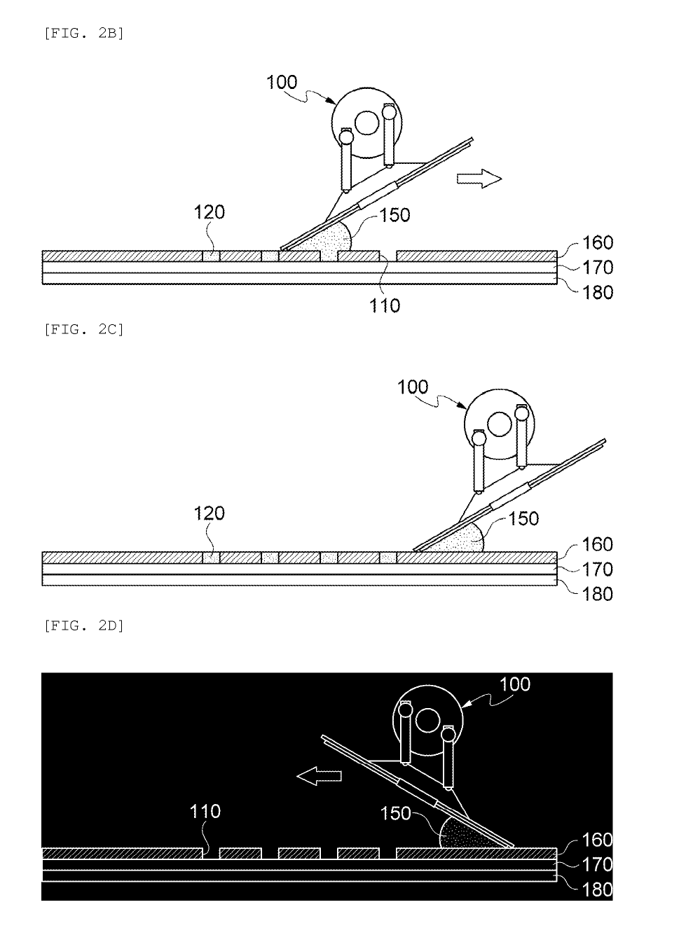

FIGS. 2A to 2D are diagrams schematically showing processes for illustrating a method of manufacturing a circuit board according to an exemplary embodiment of the present invention.

Referring to FIG. 2A, a circuit board 170 is located on a printing table 180, a mask for screen printing 160 is disposed on the circuit board 170, solder paste for bumps 150 is provided on the mask 160, and a squeegee for solder paste printing 100 having first and second squeegee blades 41 and 42 coupled with each other is disposed at a side on the mask 160 from which a first printing is to be initiated. The providing of the solder paste 150 and the disposing of the squeegee 100 may be performed in different order.

Preferably, the mask 160 may be made of photosensitive material. For instance, the mask may use a dry film used in existing circuit manufacturing processes as the photosensitive material, and may form openings 110 to be filled with the solder paste 150 using a typical photolithography process. Using the mask 160 made of photosensitive material as above is advantageous in that it can satisfy the quality levels of heights and shapes required in fine-pitch bumps.

Optionally, a known process to align the printing table 180, the circuit board 170, and the mask 160 may be performed (not shown).

Next, referring to FIG. 2B, as the squeegee 100 moves from one side to the other side of the mask 160, e.g., to the right as indicated by the arrow, the solder paste 150 fills the openings 110 in the mask 160 so that bumps are printed on the circuit board 170. When the squeegee blades 40 are located on the mask 160 right before the squeegee 100 begins to print, solder paste may be added between a first squeegee blade 41 and a second squeegee blade 42, as necessary.

While the first squeegee blade 41 is sliding, the second squeegee blade 42 slides with a predetermined distance therefrom, such that the second squeegee blade 42 processes holes on the mask printed by the first squeegee blade 41 where faults exist. That is, the second squeegee blade 42 may supplement insufficient solder paste or remove excessive solder paste.

Optionally, referring to FIG. 2C, after the squeegee 100 slides to the other side of the mask 160, i.e., the first print finish point, the squeegee 100 is elevated, the printed circuit board 170 is detached, and a new circuit board 170 may be placed on the printing table 180.

Next, referring to FIG. 2D, the rotation module 10 of the squeegee 100 is reversely rotated such that the heights of the rods are reversed, and the squeegee blades 40 face the opposite direction (symmetric with respect to y axis), and descend to the other side, i.e., the second print start point. Here, the gradient of the squeegee may be suitably adjusted for the second printing direction (for example, to the left indicated by the arrow). If there is much residual solder paste moved by the squeegee blade 40, it is used in the second printing. Otherwise, solder paste 150 may be added to the mask 160 before or after the squeegee 100 is descended. The providing of the solder paste 150 and the disposing of the squeegee 100 may be performed in different order.

As set forth above, according to embodiments of the present invention, the limitation and influence due to the open size and shape of solder bumps can be reduced by using squeegee blades of same or different materials, thereby to form a desired bump volume.

Further, according to embodiments of the present invention, solder paste can be printed on a circuit board by a single sliding, such that working time is significantly reduced and thus efficiency can be improved. In addition, the life of the squeegee can be elongated, and cost can be saved.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

1. A solder paste print squeegee, comprising:
a rotation module driven rotatably;
a pair of rods coupled with the rotation module in parallel;
a squeegee holder coupled with the lower ends of the pair of rods and having a trapezoid shape; and
a pair of squeegee blades supported by the squeegee holder.

2. The squeegee according to claim 1, wherein the pair of squeegee blades includes a first squeegee blade shorter than a second squeegee blade.

3. The squeegee according to claim 2, wherein the material of one squeegee blade of the pair of squeegee blades is different from that of the other squeegee blade.

4. The squeegee according to claim 3, wherein the thickness of the first squeegee blade is different from that of the second squeegee blade.

5. The squeegee according to claim 1, wherein the pair of rods includes at least one rod and is fixed to the rotation module.

6. A method of printing solder paste on a circuit board, in which the solder paste is provided on a metal mask and the solder paste fills holes formed on the metal mask, the method comprising:
locating a circuit board under a screen print mask;
placing on the mask a solder paste print squeegee having a first squeegee blade and a second squeegee blade integrally coupled with each other;
first printing solder paste on the circuit board by sliding the solder paste print squeegee from one side to the other side of the mask;
detaching the printed circuit board and locating a new circuit board; supplementing solder paste; and
second printing bumps on the circuit board by sliding from the other side to the one side of the solder paste print squeegee.

7. The method according to claim 6, wherein if a first squeegee blade removes a part of the solder paste filling the holes while the solder paste print squeegee is sliding, a following second squeegee blade fills the removed holes with solder paste.

8. The method according to claim 7, wherein in the second printing, the squeegee blades of the solder paste print squeegee have the opposite direction to that of the first printing, and a gradient forming unit is adjustable so that the gradients of the squeegee blades in the first printing and second printing are symmetric with respect to y axis.

9. The squeegee according to claim 2, wherein the pair of rods includes at least one rod and is fixed to the rotation module.

10. The squeegee according to claim 3, wherein the pair of rods includes at least one rod and is fixed to the rotation module.

11. The squeegee according to claim 4, wherein the pair of rods includes at least one rod and is fixed to the rotation module.
